(19) United States
(12) Patent Application Publication
(10) Pub. No.: US 2007/0053415 A1
(43) Pub. Date: Mar. 8, 2007

(54) Method and system for receiving dsss signal

(75) Inventor: Anthony D. Sayers, Crawley (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/570,212

(22) PCT Filed: Aug. 26, 2004
(86) PCT No.: PCT/IB04/02798

§ 371 Date: Feb. 28, 2006

(30) Foreign Application Priority Data
Sep. 3, 2003 (GB) 0320576.2
Dec. 16, 2003 (GB) 0329067.3

(51) Int. Cl. H04B 1/00

(52) U.S. Cl. 375/142

(57) ABSTRACT

A method of, and a radio system (10, 12) for and a low cost receiver (12) for, receiving a Direct Sequence Spread Spectrum (DSSS) signal uses a channel filter (46) having a passband narrower than the bandwidth of the DSSS signal. Optionally the channel filter (46) is scanned incrementally across the bandwidth of the transmitted signal, and an acceptable operating frequency is selected based on a best correlation score. Optionally the bandwidth of the channel filter (46) may be changed to improve the quality of reception.

The present invention relates to a method of, and a receiver for, receiving a Direct Sequence Spread Spectrum (DSSS) signal, and to a wireless system. The present invention has particular, but not exclusive, application in low cost radio systems such as low cost wireless networks.

Conventionally, a radio transmitter and a receiver both contain an accurate frequency reference implemented by means of a quartz crystal. As both the transmitter and the receiver know the frequency accurately, the receiver filter can be accurately matched to the transmitted spectrum using a fine tuning block. The provision of a fine tuning block in a receiver integrated circuit introduces not only complexity but also requires a relatively large area of a chip. Inevitably this makes the receiver chip relatively costly which mitigates against reducing the price of the receiver. Reducing the number of components in the fine tuning block, such as dispensing with the relatively expensive quartz crystal, will affect adversely the performance of the conventional receiver.

An object of the present invention is to reduce the cost of a radio receiver.

According to one aspect of the present invention there is provided a method of receiving a Direct Sequence Spread Spectrum (DSSS) signal, comprising down-converting the DSSS signal, filtering the down-converted DSSS signal in a channel filter having a bandwidth which is narrower than that of the DSSS signal, and correlating the filtered signal with a sequence equal to that used in spreading the spectrum.

According to a second aspect of the present invention there is provided a wireless system comprising a primary station having means for transmitting a Direct Sequence Spread Spectrum (DSSS) signal and at least one secondary station including a receiver having down-conversion means for down-converting the DSSS signal, a channel filter for filtering the down-converted DSSS signal, the channel filter having a bandwidth which is narrower than that of the DSSS signal, and correlation means for correlating the filtered signal with a sequence equal to that used in spreading the spectrum.

According to a third aspect of the present invention there is provided a receiver for receiving a Direct Sequence Spread Spectrum (DSSS) signal, the receiver having down-conversion means for down-converting the DSSS signal, a channel filter for filtering the down-converted DSSS signal, the channel filter having a bandwidth which is narrower than that of the DSSS signal, and correlation means for correlating the filtered signal with a sequence equal to that used in spreading the spectrum.

In the present specification and claims, by “narrower” bandwidth is meant that the 3 dB bandwidth of the channel filter is no greater than substantially three quarters of, but more typically half of, the 3 dB bandwidth of the DSSS signal, that is, the matched filter bandwidth in a conventional receiver of the type mentioned generally in the preamble of this specification.

The present invention is based on the realisation that at least for DSSS signals, a transmitted signal can be received using a narrower bandwidth channel filter than is conventionally used. This contrasts with conventional practice in which the filter bandwidth is matched to the signal bandwidth and is selected for good sensitivity while rejecting adjacent channel signals. Tuning of a conventional filter is desirable because if the filter is off-tune it would allow through adjacent channel signals which is undesirable. In contrast, a narrower bandwidth channel filter will automatically reject adjacent channels even if off-tune, thus avoiding the need for tuning and the provision of tuning components.

The narrower bandwidth channel filter ensures that the receiver will continue to acquire the transmitted signal even if limited amounts of frequency drift occur between the centre frequencies of the transmitted signal and the channel filter. Using this approach the receiver can be manufactured having integrated passive frequency determining components, which have a typical accuracy of between 5% and 10%, and the use of a relatively costly quartz crystal can be avoided.

In an embodiment of the present invention the bandwidth of the channel filter is substantially half that of the DSSS signal.

At least some of the loss in sensitivity resulting from the use of a narrower bandwidth channel filter may be offset by increasing the power of the transmitted signal, by say 3 dB.

There is a trade-off between avoiding the need for tuning and having to accept a loss in sensitivity. By using a channel filter having a narrower bandwidth than the transmitted signal, a tuning block, if used, can be a relatively coarse tuning block having fewer components and less complexity than a fine tuning block.

A tuning procedure using a coarse tuning block may be implemented each time the designated or acting base station in a wireless network contacts a new slave station. Also a tuning procedure may be repeated at intervals by a slave station already registered on the wireless network to ensure it remains tuned at least coarsely to the base station transmitter.

In a refinement of the present invention the output frequency of a reference signal generator used in frequency down-converting a received signal is adjustable and in operation the reference frequency is adjusted until an acceptable correlation is achieved between the received DSSS signal and a locally generated direct sequence.

In another refinement, the bandwidth of the channel filter is varied incrementally to improve reception of the DSSS signal.

The present invention will now be described, by way of example, with reference to the accompanying drawings, wherein:

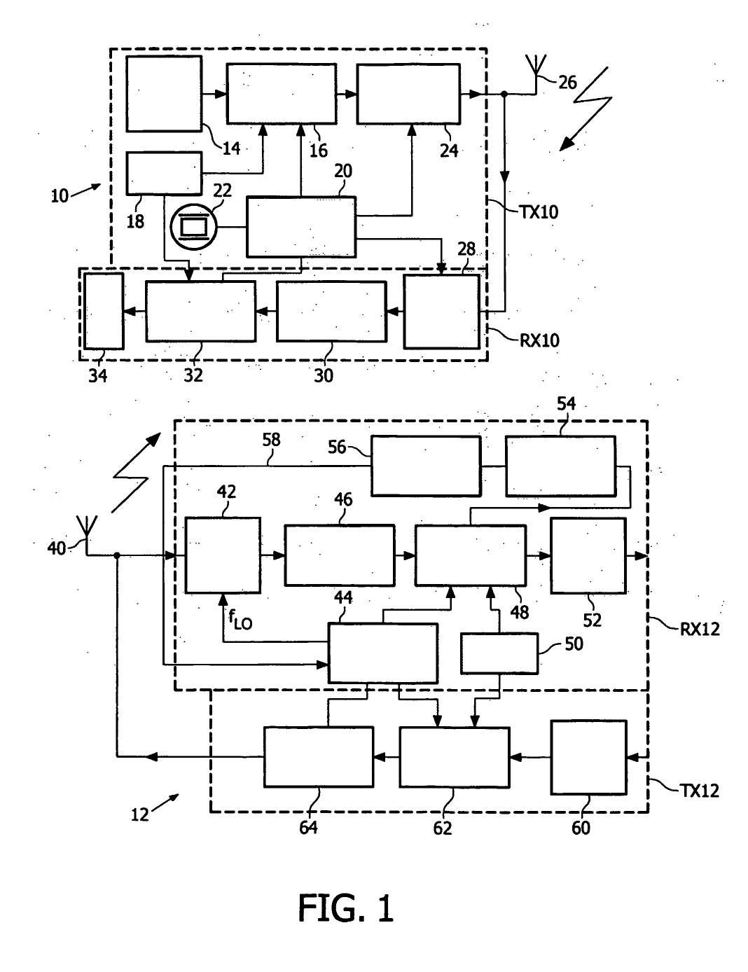

FIG. 1 is a block schematic diagram of an embodiment of a low cost wireless network made in accordance with the present invention,

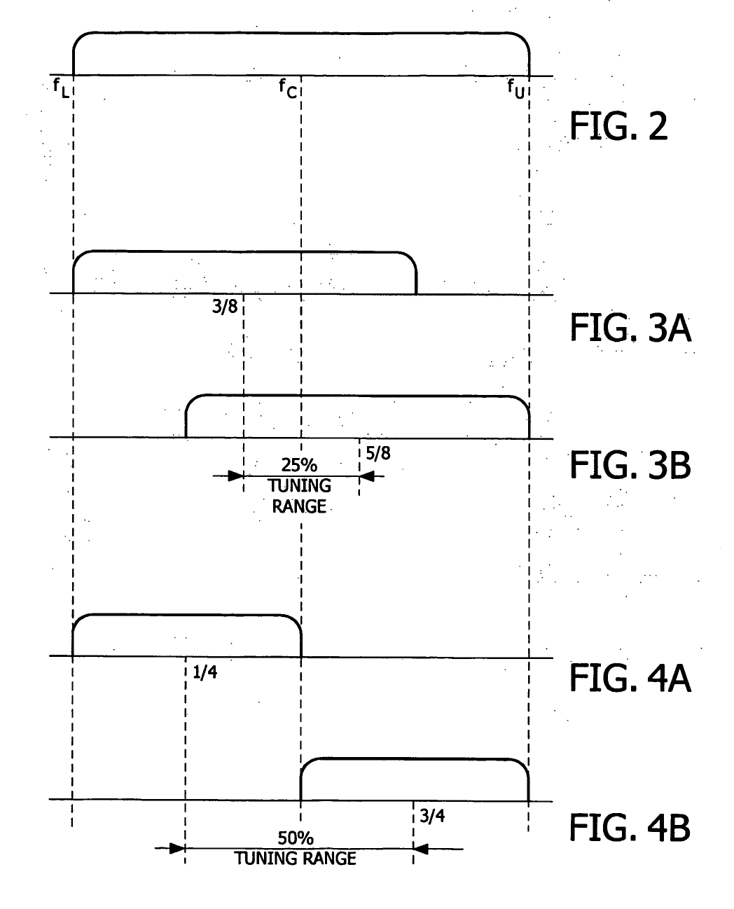

FIG. 2 illustrates diagrammatically the spectrum of a transmitted DSSS signal,

FIGS. 3A and 3B illustrate diagrammatically the upper and lower limits of a channel filter having a bandwidth of the order of 75% of the transmitted DSSS signal,

FIGS. 4A and 4B illustrate diagrammatically the upper and lower limits of a channel filter having a bandwidth of the order of 50% of the transmitted DSSS signal,

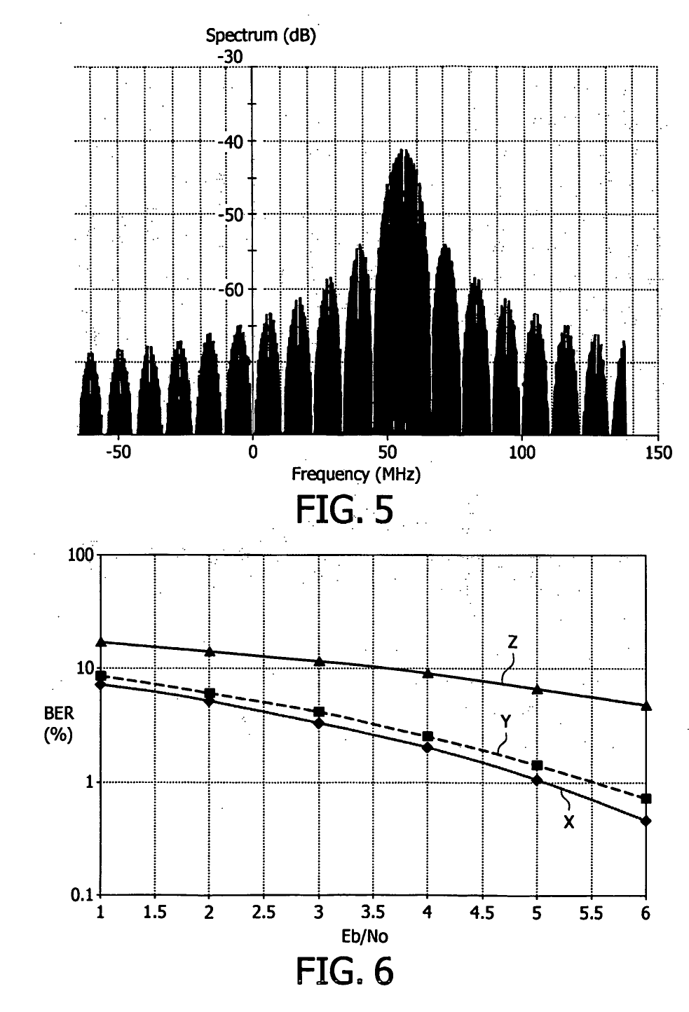

FIG. 5 illustrates an example of a spectrum of a DSSS signal,

FIG. 6 is a graph of bit error rate (BER) for different channel filter bandwidths,

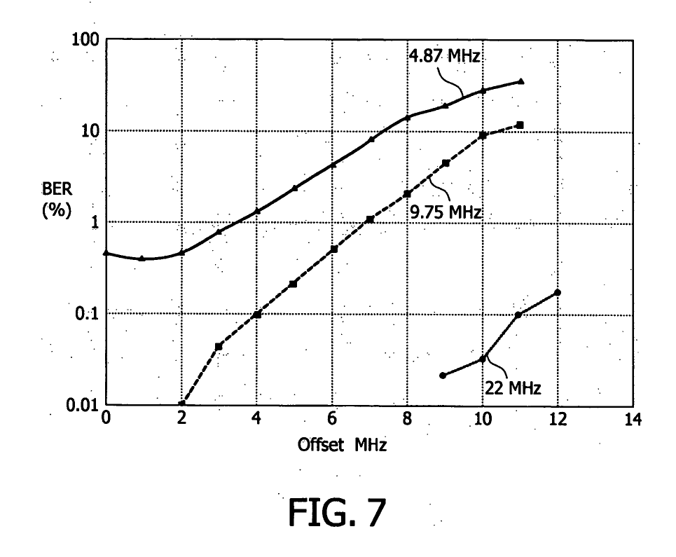

FIG. 7 is a graph illustrating the effect of frequency offset on BER,

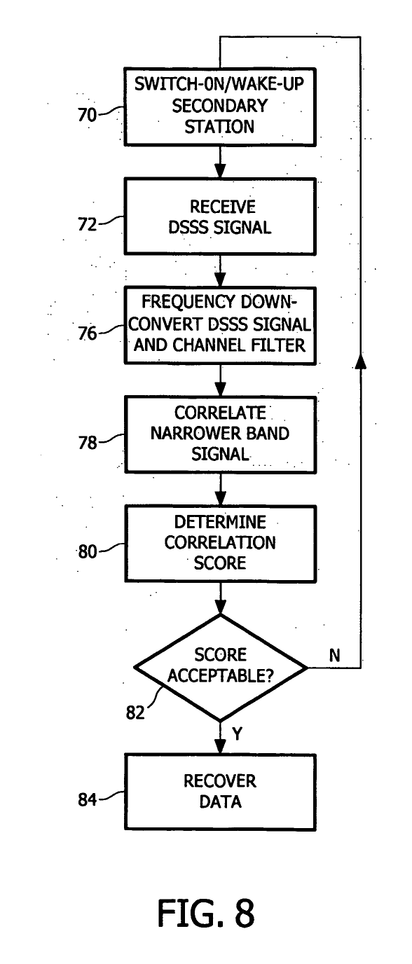

FIG. 8 is a flow chart of an embodiment of the method in accordance with the present invention,

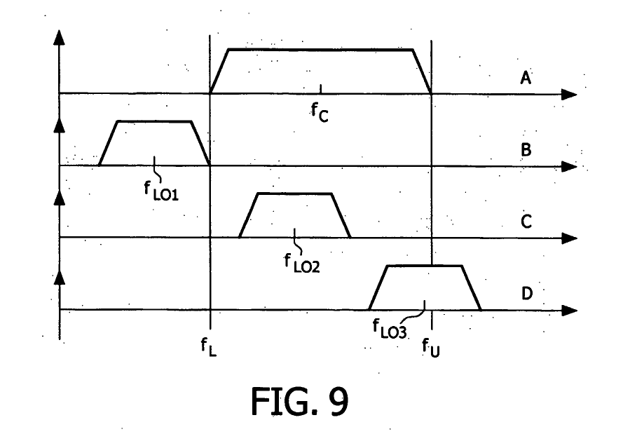

FIG. 9 comprises diagrams A, B, C and D illustrating a variant of the method in accordance with the present invention in which the channel filter bandwidth is shifted relative to the centre frequency of the transmitted DSSS signal, and

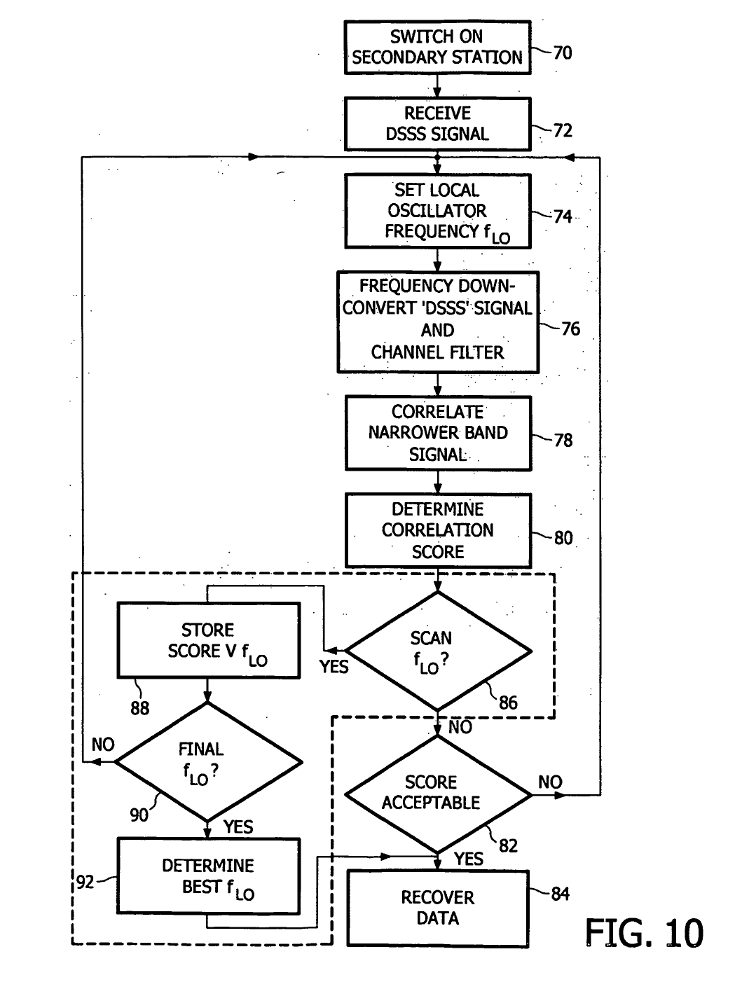

FIG. 10 is a flow chart of the process of aligning the secondary station's receiver with the primary station's transmitter.

In the drawings the same reference numerals have been used to indicate corresponding features.

Referring to FIG. 1, the low cost wireless network comprises a primary (or base) station 10 and a plurality of secondary (or portable) stations 12 of which only one is illustrated for the sake of clarity. The wireless network is intended for use in the 2.4 GHz ISM band which has a width of the order of 85 MHz, a fractional bandwidth of about 3.5%. The primary station 10 comprises a transceiver including a transmitter section TX10 and a receiver section RX10 and the secondary station also comprises a transceiver including a transmitter section TX12 and a receiver section RX12. Both types of station have other parts but these have not been shown as they are not relevant to the understanding of the present invention. The signal transmitted by the transmitter section TX10 is spread across the entire band using an antipodal (±1) 11 bit Barker sequence. In the following description such a direct sequence spread spectrum signal is termed a DSSS signal.

The transmitting section TX10 comprises a source of data 14 which is coupled to a DSSS signal generator 16. A code store 18 storing the 11 bit Barker sequence and a reference frequency source 20 whose output frequency is stabilised using a crystal 22 are coupled to the signal generator 16. A DSSS signal output of the signal generator 16 is coupled to a first input of a modulator 24. An output of the reference frequency source 20 is coupled to a second input of the modulator 24. An antenna 26 is coupled to an output of the modulator 24.

The receiving section RX10 comprises a frequency down-converter 28 having a first input coupled to the antenna 26 and a second input coupled to the reference frequency source 20. The signals received at the antenna 26 of the primary station 10 will, as will be explained later, be DSSS signals with a bandwidth that may be narrower than the bandwidth of those transmitted by the primary station 10. A wideband channel filter 30 is coupled to an output of the frequency down-converter 28 and will pass any narrower bandwidth signals falling within its passband. A despread and correlating stage 32 is coupled to an output of the wideband channel filter 30 and to an output of the code store 18. A baseband output stage 34 is coupled to an output of the stage 32 to provide a data signal output.

Referring now to the secondary station 12, the receiver RX12 comprises a frequency down-converter 42 having a signal input coupled to an antenna 40. A reference frequency generator 44 provides a local oscillator signal f_{LO} to the frequency down-converter 42. The reference frequency generator 44 is a low cost device having passive, integratable frequency determining components. The tolerance and stability of the frequency generated is governed by the characteristics of the process used to make the receiver RX12 integrated circuit. As a cost saving measure, a frequency stabilising element, such as a quartz crystal, is not provided. However, the architecture of the reference frequency generator 44 is of no significance to implementing the method in accordance with the present invention.

The downconverted DSSS signal from the frequency down-converter 42 is filtered in a channel filter 46 which has a narrower bandwidth than the signal transmitted by the primary station 10. A sliding correlator 48, which may be implemented in a known way using a series of flip-flops, is coupled to the channel filter 46 to receive the filtered DSSS signal. The sliding correlator 48 also has inputs for a timing signal derived from the reference frequency generator 44 and an input for a duplicate of the 11 bit Barker code used in spreading the signal in the transmitter TX10, which code is held in a code store 50. An output stage 52 is coupled to an output of the sliding correlator 48 to provide a signal output, such as a data signal or an indication of signal presence.

A correlation scoring stage 54 is coupled to an output of the sliding correlator 48. An output of the correlation scoring stage 54 is coupled to an input of a microcontroller 56. The sliding correlator 48 produces an indication of the relative degree of correlation achieved with the current input signal from the channel filter 46. If the indication, when compared to a reference value or scale of values by the correlation scoring stage 54, is deemed to be acceptable according to a predetermined criterion, then the receiver RX12 is regarded as having acquired the transmitted signal and the microcontroller 56 controls the receiver RX12 to remain energised to provide the output signal at the output stage 52, but alternatively if it is deemed to be unacceptable then the receiver RX12 reverts to a sleep mode or is de-energised.

The transmitter TX12 of the secondary station 12 comprises a data input stage 60 which is coupled to a DSSS stage 62. Outputs from the reference frequency generator 44 and the code store 50, which provides the 11 bit Barker code, are also connected to the stage 62. The DSSS signal from the stage 62 is then modulated in a modulator 64 and the result is supplied to the antenna 40 for propagation to the primary station 10.

This signal transmitted by the secondary station 12 may have a narrower bandwidth than the DSSS signal transmitted by the primary station 10. The receiver RX10 will have no difficulty in processing such a narrower bandwidth DSSS signal as its bandwidth will lie within the passband of its channel filter 30, even if the centre frequency of the transmitter TX12 is not aligned perfectly with the local oscillator frequency of the receiver RX 10.

FIG. 2 illustrates diagrammatically the bandwidth of the DSSS signal transmitted by the primary station 10. The illustrated band has a centre frequency f_{c} and upper and lower frequency limits fᵤ and f_{L}, respectively. In accordance with the present invention the bandwidth of the channel filter 46 is less than the bandwidth of the transmitted signal and is ideally centred substantially on the centre frequency f_{c} of the transmitted signal. However for various reasons including component tolerances and temperature effects this ideal arrangement may not prevail and the centre of the channel filter bandwidth may not be the same as f_{c}. Also the bandwidth may drift. Nevertheless provided that a DSSS signal is received and results in an acceptable correlation score, or has an acceptable bit error rate (BER), then the secondary station can be regarded as having acquired the transmitted signal.

FIGS. 3A and 3B respectively illustrate the situation for a channel filter having a 3 dB bandwidth corresponding to three-quarters (or 75%) of the transmitted signal. In FIG. 3A the lower edge of the filter bandwidth has a frequency corresponding to f_{L} and in FIG. 3B the upper edge of the filter bandwidth has a frequency corresponding to fᵤ. Thus it is possible for the centre frequency of the channel filter 46 to drift or be misaligned by ± one eighth of the transmitted bandwidth and still be capable of receiving the transmitted signal without receiving signals from an adjacent channel.

Narrowing the channel filter bandwidth to half (or 50%) of the transmitter bandwidth as shown in FIGS. 4A and 4B, FIG. 4A showing the lower frequency limit and FIG. 4B showing the higher frequency limit, makes it possible for the centre frequency of the filter 46 to drift or be misaligned by ± one quarter of the transmitted bandwidth and still be capable of receiving the transmitted signal without receiving signals from an adjacent channel.

If the filter bandwidth lies at least partially outside the frequencies fᵤ or f_{L} then the quality of the received signal will deteriorate and the bit error rate will grow to a point that it will not be regarded as having acquired the wanted channel. In the event of there being adjacent channel signals, they will not correlate with the receiver's code and will appear as noise.

Referring to FIG. 5, the spread spectrum of the DSSS signal transmitted by the primary station 10 comprises a sequence of lobes centred at a simulated carrier frequency of 55 MHz. In a real application the outer lobes of the transmitted spectrum are filtered-out by post modulation filtering, but this does affect the demodulation of the central, main lobe. More particularly the transmitted signal comprises a BPSK signal with a data rate of 1 MHz which is subject to spreading by an 11-bit Barker sequence. The chip rate is thus 11 MHz, and the system sampling rate is 275 MHZ, viz. over sampling by a factor of 25. The channel filter 46 (FIG. 1) simulated is a 20 tap Butterworth filter and the 3 dB-3 dB bandwidths used for the simulation were (a) 22 MHz which sets the 3 dB points of the channel filter at the first nulls of the transmitted spectrum, (b) 9.75 MHz which sets the 3 dB points of the channel filter at the 3 dB points of the transmitted spectrum, and (c) 4.87 MHz which is half the preceding value. The channel filter was initially set at the centre frequency of the wanted signal.

FIG. 6 shows the results of the measured bit error rate (BER) of the receiver. As the channel filter bandwidth is reduced from 22 MHz (curve X) to 9.75 MHz (curve Y), the performance of the system degrades by about 0.6 db. An interpretation of this result is that most of the information carried by the system still resides within the 9.75 MHz bandwidth. This is the 3 dB bandwidth in a conventional receiver.

As the channel filter bandwidth is reduced below the conventional 3 dB bandwidth of 9.75 MHz to 4.87 MHz (curve Z), the performance of the system degrades by about 3.3 dB. Nevertheless it has been found possible to operate with such a degraded performance. It is possible to compensate for such a degraded performance by for example increasing transmitter power.

FIG. 7 illustrates the effect of frequency offset on the bit error rate. When the filter is not centred on the transmitted spectrum, the signal is degraded due to the fact that the transmitted power received in the filter is smaller and the distribution of energy across the spectrum is altered. The system can however tolerate quite large offsets, for example about 3.5 MHz for a doubling of the bit error rate (4.87 MHz filter).

When the offset is 11 MHz (that is, the channel filter is on the null in the transmitted spectrum) it is theoretically possible to retrieve some information, although the BER is severely degraded due to the fact that the signal amplitude is so small.

FIG. 8 is a flow chart which summarises the operations described. Block 70 relates to switching-on or waking-up a secondary station 12 (FIG. 1). Block 72 relates to the receiver RX12 (FIG. 1) receiving a DSSS signal. Block 76 relates to the DSSS signal being frequency down-converted and for the products of mixing being filtered in a channel filter 46 (FIG. 1) to form a signal with a narrower bandwidth. Block 78 relates to using the sliding correlator 48 (FIG. 1) to attempt to correlate this narrower bandwidth signal. Block 80 relates to the correlation scoring stage 54 (FIG. 1) determining the degree of correlation and providing a score or other appropriate indication. In block 82 a check is made to see if the score is acceptable. If it is (Y) the receiver RX12 is regarded as having acquired the transmitted signal and in block 84 the data is recovered. If the score is unacceptable (N), the flow chart reverts to the block 70 and either the receiver is de-energised or is placed into a sleep mode.

In a variant of the embodiment of the invention described with reference to FIG. 1 the channel filter can be coarsely tuned over a frequency range, which may exceed that of the transmitted bandwidth. In this variant the reference frequency generator 44 is tunable under the control of an output 58 of the microcontroller 56. The reference frequency generator 44 includes at least one integratable frequency determining component such as a varactor.

In operation if the degree of correlation is deemed to be low, which indicates that the channel filter 46 does not lie within, or sufficiently close to the centre of, the bandwidth of the received DSSS signal, then the correlation scoring stage 54 produces an appropriate output which is supplied to the microcontroller 56. The microcontroller 56 sends an appropriate tuning signal on its output 58, which signal causes the reference frequency generator 44 to alter the local oscillator frequency f_{LO}. The cycle of operations is repeated for different local oscillator frequencies until an acceptable output is obtained from the correlation scoring stage 54. Alternatively a sequence of cycles may be instituted in which the local oscillator frequency f_{LO} is altered to scan the entire bandwidth of the DSSS signal. The scores obtained by the correlation scoring stage 54 are examined by the microcontroller 56 which selects the local oscillator frequency f_{LO} giving the best, or an acceptable, score. In either case the receiver RX12 will be regarded as being in tune with the transmitter TX10.

If the primary station 10 is in contact with a particular secondary station 12 for a relatively long time then as a precaution against signal loss due to excessive drift in the local oscillator frequency f_{LO}, the microcontroller 56 may initiate another scan.

When a secondary station 12 joins a Wireless Local Area Network (WLAN) or becomes active after being dormant, the tuning of its receiver RX12 is carried-out.

The frequency shifting of the channel filter 46 will now be described with reference to FIG. 9 which comprises diagrams A, B, C and D.

Diagram A, which is similar to FIG. 2, illustrates the DSSS signal transmitted by the primary station 10. Diagram B illustrates the position of the channel filter 46 (FIG. 1) for a first value of local oscillator frequency f_{LO1}. As is evident from a comparison of diagrams A and B, there is no overlap between the channel filter 46 and the transmitted signal so that the sliding correlator 48 (FIG. 1) will not detect any correlation and the correlation scoring stage 54 (FIG. 1) will give an appropriate low output which may be an absolute value or merely a low/unacceptable indication. Any adjacent channel interferers will also have low correlation scores.

Diagram C illustrates the situation for a local oscillator frequency f_{LO2} which places the channel filter 46 well within the bandwidth of the DSSS signal thereby giving a high degree of correlation. Consequently a high or acceptable indication will be provided by the correlation scoring stage 54.

Diagram D illustrates the situation for a local oscillator frequency f_{LO3} which causes the channel filter 46 to partially overlap the high end of the bandwidth of the DSSS signal thereby giving a low degree of correlation. Consequently a low or unacceptable indication will be provided by the correlation scoring stage 54.

Once the scan of local oscillator frequencies has been completed, the microcontroller 56 selects the local oscillator frequency f_{LO2} as the best frequency which gives the best correlation score or the best BER. After acquisition has been achieved, various refinements, not shown, can be brought into use to process or enhance the processing of the received DSSS signal.

FIG. 10 is a flow chart which summarises the operations described with reference to FIG. 9 together with a variant in the process described below. Block 70 relates to switching on a secondary station 12 (FIG. 1). Block 72 relates to the receiver RX12 (FIG. 1) receiving a DSSS signal. Block 74 relates to the receiver RX12 setting a local oscillator frequency f_{LO}. Block 76 relates to the DSSS signal being frequency down-converted using the set local oscillator frequency and for the products of mixing being filtered in a channel filter 46 to form a signal with a narrower bandwidth. Block 78 relates to using the sliding correlator 48 (FIG. 1) to attempt to correlate this narrower bandwidth signal. Block 80 relates to the correlation scoring stage 54 (FIG. 1) determining the degree of correlation and providing a score or other appropriate indication. In block 82 a check is made to see if the score is acceptable. If it is (Y), the receiver is regarded as having acquired the transmitted signal and in block 84 the data is recovered. If the score is unacceptable (N), the flow chart reverts to the block 74 and another local oscillator frequency f_{LO} is set and the cycle is repeated.

A variant of the process will now be described and illustrated by the blocks 86, 88, 90 and 92 in FIG. 10. The block 86 is inserted between the blocks 80 and 82 and serves to check if the local oscillator frequency f_{LO} should be scanned. If the answer is no (N), the flow chart proceeds to the block 82 and so on. If the answer is yes (Y) then in block 88 the microcontroller 56 effects a scan to find the best local oscillator frequency by storing the correlation score against the respective local oscillator frequency. In block 90 a check is made to see if the final local oscillator frequency f_{LO} has been used. If the answer is No (N) then the flow chart reverts to the block 74. If the answer is yes (Y) the flow chart proceeds to block 92 which determines which local oscillator frequency gives the best score and provides an appropriate output to the block 84 in which the data is recovered.

When choosing the bandwidth of the channel filter 46 account should be taken of the accuracy and stability of the reference frequency generator 44 and the maximum search time permitted. In simulation a bandwidth of 50% of the bandwidth of the transmitted DSSS signal has been found to be acceptable with 75% being the upper limit.

In another variant of the method in accordance with the present invention the bandwidth of the channel filter 46 is varied, for example reduced, incrementally in steps to avoid adjacent channel interference. The sequence of operations is similar to that described with reference to FIG. 10 but with the differences that the operation represented by the block 74 is replaced by the operation of altering the bandwidth of the filter and that the blocks 86, 88 and 90 are not required.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of low cost radios and component parts therefor and which may be used instead of or in addition to features already described herein.

1. A method of receiving a Direct Sequence Spread Spectrum (DSSS) signal, comprising down-converting the DSSS signal, filtering the down-converted DSSS signal in a channel filter (46) having a bandwidth which is narrower than that of the DSSS signal, and correlating (78) the filtered signal with a sequence equal to that used in spreading the spectrum.

2. A method as claimed in claim 1, comprising determining (80, 82) if the degree of correlation is acceptable according to a predetermined criterion, and if acceptable providing an output signal.

3. A method as claimed in claim 2, comprising varying a centre frequency of the channel filter (46), monitoring the degree of correlation for each centre frequency, and selecting a centre frequency that provides an acceptable degree of correlation.

4. A method as claimed in claim 1, wherein the bandwidth of the channel filter (46) is substantially half that of the DSSS signal.

5. A wireless system comprising a primary station (10) having means (TX10) for transmitting a Direct Sequence Spread Spectrum (DSSS) signal and at least one secondary station (12) including a receiver (RX12) having down-conversion means (42) for down-converting the DSSS signal, a channel filter (46) for filtering the down-converted DSSS signal, the channel filter (46) having a bandwidth which is narrower than that of the DSSS signal, and correlation means (48) for correlating the filtered signal with a sequence equal to that used in spreading the spectrum.

6. A system as claimed in claim 5, the receiver (RX12) comprising means (54, 56) for determining if the degree of correlation is acceptable according to a predetermined criterion, and means (52) for providing an output signal if acceptable the degree of correlation is acceptable.

7. A system as claimed in claim 6, the receiver (RX12) further comprising a reference frequency generator (44) including frequency adjusting means for adjusting its output frequency, and control means (56) for causing the reference frequency generator (44) to adjust its output frequency to provide an acceptable degree of correlation.

8. A system as claimed in claim 5, wherein the bandwidth of the channel filter (46) is substantially half that of the DSSS signal.

9. A receiver (RX12) for receiving a Direct Sequence Spread Spectrum (DSSS) signal, the receiver having down-conversion means (42) for down-converting the DSSS signal, a channel filter (46) for filtering the down-converted DSSS signal, and correlation means (48) for correlating the filtered signal with a reference sequence, wherein the bandwidth of the channel filter (46) is narrower than the bandwidth of the DSSS signal.

10. A receiver as claimed in claim 9, the receiver (RX12) comprising means (54, 56) for determining if the degree of correlation is acceptable according to a predetermined criterion, and means (52) for providing an output signal if acceptable the degree of correlation is acceptable.

11. A receiver as claimed in claim 10, further comprising a reference frequency generator (44) including frequency adjusting means for adjusting its output frequency, and control means (56) for causing the reference frequency generator (44) to adjust its output frequency to provide an acceptable degree of correlation.

12. A receiver as claimed in claim 11, characterised in that the reference frequency generator comprises integrated frequency determining components.

13. A receiver as claimed in claim 9, characterised in that the bandwidth of the channel filter (46) is substantially half that of the DSSS signal.
